(19) United States
(12) Patent Application Publication
(10) Pub. No.: US 2009/0051318 A1
(43) Pub. Date: Feb. 26, 2009

(54) Pass Around Electrical Contacts

(76) Inventors: Christopher R. Paul, Bayport, NY (US); Thomas Wulff, North Patchogue, NY (US); William R. Bang, Baiting Hollow, NY (US); Carl Degiovine, Shirley, NY (US)

Correspondence Address: Fay Kaplun & Marcin, LLP/ Motorola, 150 Broadway Suite 702, New York, NY, 10038, US

(21) Appl. No.: 11/843,344

(22) Filed: Aug. 22, 2007

(51) Int. Cl. H02J 7/00

(52) U.S. Cl. 320/114; 361/679

(57) ABSTRACT

A battery comprises a housing, a plurality of contacts, and a pass around electrical contact. The housing includes a plurality of rechargeable cells. The plurality of contacts electrically couple to the rechargeable cells. The plurality of contacts are configured to couple to first corresponding contacts of an electronic device. The pass around electrical contact is electrically isolated on the battery from the plurality of contacts and is configured to couple to second corresponding contacts of the electronic device. The pass around electrical contact is further configured to be connected to at least one of an external power supply and a data source.

### FIELD OF THE INVENTION

The present invention relates generally to an electrical contact that passes around a battery. Specifically, the pass around electrical contact may establish an electrical connection from an external power supply or a data source to a mobile unit around the battery.

### BACKGROUND

An electronic device may connect to an external power supply. The external power supply may be used to power the components of the electronic device. When the electronic device is a mobile unit, the external power supply may also be used to recharge a battery. If the mobile unit is not equipped with a charger, the battery is required to be removed and placed into a charger. If the mobile unit is equipped with a charger, the mobile unit may include a port that receives a connector from the external power supply. This port is often disposed toward a periphery of a housing of the mobile unit. A power contact that electrically connects the external power supply to the electronic device may be sizable and require additional space. Replacement of a damaged power contact may also be intrusive. That is, the mobile unit must be dismantled in order to properly replace the damaged power contact.

The battery may include a power path through the battery, inside the battery pack itself. The external power supply may be connected to the battery on a side that is exposed when the battery is plugged into the mobile unit. The power path may be routed around the battery and through pins on the terminal side of the battery. The pins may occupy the same connector as other signals which pass solely between the mobile unit and the battery. That is, the use of the pins overlap for a signal path between the battery and the mobile unit and between the external power supply and the mobile unit. The common usage of pins may cause unintended results. For example, an electrical connection to other signals may be established during high voltages associated with electrostatic discharge events. Consequently, the battery may be at a higher risk of being damaged.

### SUMMARY OF THE INVENTION

The present invention relates to a battery comprising a housing, a plurality of contacts, and a pass around electrical contact. The housing includes a plurality of rechargeable cells. The plurality of contacts electrically couple to the rechargeable cells. The plurality of contacts are configured to couple to first corresponding contacts of an electronic device. The pass around electrical contact is electrically isolated on the battery from the plurality of contacts and is configured to couple to second corresponding contacts of the electronic device. The pass around electrical contact is further configured to be connected to at least one of an external power supply and a data source.

### DESCRIPTION OF THE DRAWINGS

FIG. 1 shows a perspective view of a back side of an electronic device according to an exemplary embodiment of the present invention.

FIG. 2 shows a perspective view of a back side of a battery according to an exemplary embodiment of the present invention.

FIG. 3 shows an assembled view of the electronic device of FIG. 1 with the battery of FIG. 2.

FIG. 4 shows a perspective view of a cradle used to recharge the battery of FIG. 2 according to an exemplary embodiment of the present invention.

FIG. 5a shows a perspective view of a second exemplary embodiment of a back side of the battery of FIG. 2.

FIG. 5b shows a perspective view of a third exemplary embodiment of a back side of the battery of FIG. 2.

### DETAILED DESCRIPTION

The present invention may be further understood with reference to the following description and the appended drawings, wherein like elements are referred to with the same reference numerals. The exemplary embodiments of the present invention describe a battery for a mobile unit (MU) that includes a pass around electrical contact. The pass around electrical contact may provide an electrical connection between an external power supply and the MU. As will be described in further detail below, the pass around electrical contact may be disposed on a periphery of the battery. The MU, the battery, and the pass around electrical contact will be discussed in more detail below.

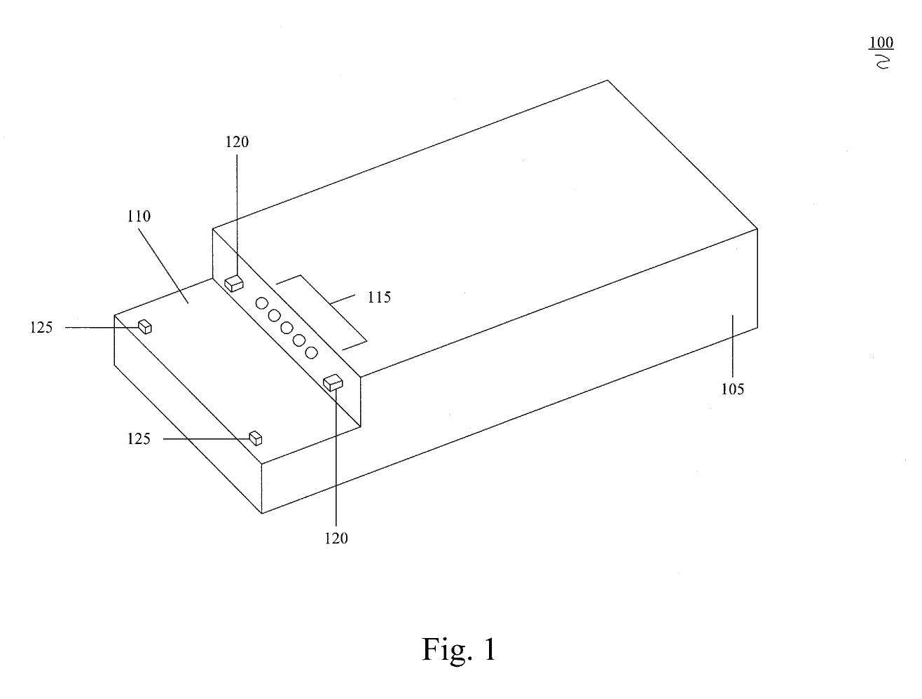

FIG. 1 shows a perspective view of a back side of an electronic device 100 according to an exemplary embodiment of the present invention. The electronic device 100 may be any device that may utilize a portable power supply such as a battery. For example, the electronic device 100 may be a personal computer, a laptop, a pager, a cell phone, a radio frequency identification device, a scanner, a data acquisition device, an imager, etc. In the exemplary embodiments, the electronic device 100 will be described as an MU. However, it should be noted that the electronic device 100 may be any type of mobile device including the above listed examples.

The electronic device 100 may include a housing 105, a recess 110, device contacts 115, secondary device contacts 120, and locking mechanisms 125. It should be noted that the electronic device 100 may include various other components. For example, the electronic device 100 may include components within the housing 105. These components may include hardware devices such as a processor, a memory, a transceiver, etc. The electronic device 100 may also include components partially within the housing 105. These components may include a data input arrangement, a display, an antenna, etc. At least one of the components may be powered by the portable power supply.

The recess 110 may be a portion of the housing 105 that is configured to receive the portable power supply. As illustrated, the housing 105 may be molded to include the recess 110. The recess 110 may extend from a bottom side of the housing 105. The recess 110 may also extend an entire length of the housing 105. That is, the recess 110 may be substantially L-shaped. Thus, when the portable power supply is received by the recess 110, at least a portion of the housing of the portable power supply may be exposed. The exposed area of the housing of the portable power supply may include a bottom side, right and left sides, and a back face.

It should be noted that the recess 110 extending an entire length of the housing 105 is only exemplary. For example, the recess 110 may be a slot that receives the portable power supply. Thus, the recess 110 may extend only a partial length of the housing 105. Additionally, if the portable power supply is received by the recess 110 that is a slot, the recess 110 may substantially surround the portable power supply. The portable power supply may still include a portion of the housing that is exposed. That is, the slot may not be enclosed and, therefore, the portable power supply may be exposed.

In another example, the recess 110 may be a slot substantially similar to the above described slot. However, the recess 110 may extend an entire length of the housing 105. Thus, a cross sectional view of the recess 110 may show a substantial square bracket shape. Consequently, the recess 110 may substantially surround the portable power supply more than the first described recess but less than the second described recess. If the portable power supply is received by the recess 110 that is a square bracket, the portable power supply may be exposed in additional areas than the second described recess. That is, the bottom side and the right and left sides of the housing of the portable power supply may be exposed.

In yet another example, the recess 110 may be completely enclosed within the housing 105. The housing 105 may include a cover or lid that eliminates any exposed area of the housing of the portable power supply. The recess 110 may be substantially similar to the first described recess. However, the housing 105 may be configured to include the cover or lid. As will be described in further detail below, the cover or lid may be used when the electronic device 100 is being used in a portable manner. That is, the electronic device 100 is not connected to a power supply and being recharged. As will also be described in further detail below, when the electronic device 100 is being recharged, the lid or cover may be removed to expose the housing of the portable power supply. It should be noted that the above described embodiments of the recess 110 is only exemplary and the recess 110 may take any form to receive the portable power supply.

It should be noted that the recess 110 may include further components. For example, the recess 110 may include channels in which rails may slide. The rails may be disposed on the housing of the portable power supply. Thus, the channels and rails may aid in the electronic device 100 receiving the portable power supply and orienting the portable power supply to be in a proper configuration. The rails may be disposed on the recess 110 while the channels are disposed on the housing of the portable power supply.

The device contacts 115 may be a plurality of contacts used to electrically couple the portable power supply with the electronic device. Specifically, the device contacts 115 may provide an electrical connection in which power from cells of the portable power supply may travel to the electronic device 100. However, the device contacts 115 may also provide an electrical connection for other signals such as data. The device contacts 115 may be, for example, pins extending out of the housing 105, flat contacts disposed on a periphery of the housing 105, pinholes extending into the housing 105, coil springs, leaf springs, pogo pins, conductive pads, torsional springs, etc. The device contacts 115 may be manufactured of a conducting material such as beryllium copper, silver, gold, etc. As illustrated, the device contacts 115 may include five contacts and be disposed within the recess 110. It should be noted that the use of five contacts is only exemplary and the device contacts 115 may include fewer or more contacts.

The secondary device contacts 120 may be a second set of contacts used to electrically couple the electronic device 100 to an external power supply. The external power supply may be from, for example, a wall socket, a generator, an alternating current (AC) to direct current (DC) converter, a DC to DC converter for vehicle power, etc. As will be described in detail below, the portable power supply may include a pass around electrical contact that provides an electrical connection from the external power supply to the electronic device 100 via the secondary device contacts 120. The secondary device contacts 120 may be of a type and material substantially similar to the device contacts 115 (e.g., pins, flat contacts, pinholes, conductive metal, etc.).

It should be noted that the device contacts 115 and the secondary device contacts 120 being disposed on a common surface is only exemplary. For example, the device contacts 115 may be located as illustrated while the secondary device contacts 120 may be disposed on a perpendicular surface. Furthermore, it should be noted that the plurality of device contacts 115 being disposed on a common surface is only exemplary. The device contacts 115 may be disposed on multiple surfaces. Furthermore, the device contacts 115 may be arranged in different configurations (e.g., zig-zag pattern). In addition, it should be noted that the secondary device contacts 120 being disposed on a common surface is only exemplary. Similar to the device contacts 115, the secondary device contacts may be disposed on multiple surfaces.

The locking mechanisms 125 may releasably affix the portable power supply to the electronic device 100. The locking mechanisms 125 may be, for example, screws, retractable inserts, snaps, hook and loop fasteners, etc. The locking mechanisms 125 may couple to a corresponding locking mechanism on the portable power supply. The corresponding locking mechanism will be described in further detail below.

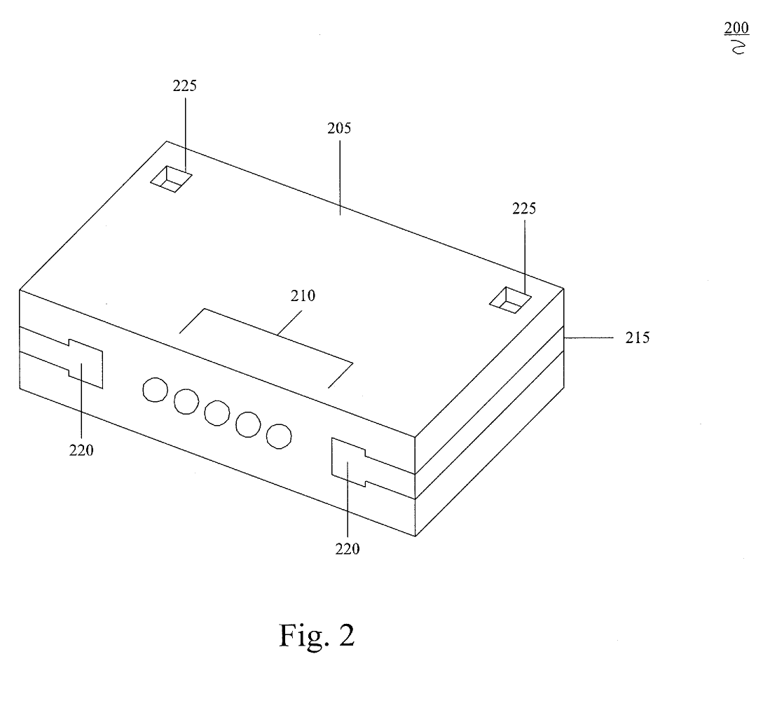

FIG. 2 shows a perspective view of a back side of a battery 200 according to an exemplary embodiment of the present invention. The battery 200 may be the portable power supply described above. That is, the battery 200 may be received by the recess 110 of the electronic device 100. The battery 200 may be a rechargeable battery such as a lithium ion (Li-Ion) battery, a lithium polymer battery, a nickel cadmium (Ni-Cad) battery, a nickel hydride (Ni—H) battery, etc. The battery 200 may include a battery housing 205, battery contacts 210, a pass around electrical contact 215, pass around electrical contact heads 220, and corresponding locking mechanisms 225. It should be noted that the battery 200 may include further components. For example, the battery 200 may include a plurality of cells that store energy and are connected to the battery contacts 210; circuitry for monitoring battery voltage and current and/or storing data for battery history, gas gauging, and/or performance.

The battery housing 205 may be substantially similar (e.g., in utility, in composition, etc.) to the housing 105 of the electronic device 100. That is, the battery housing 205 may house, for example, the cells. The battery housing 205 may be constructed of substantially similar materials as the housing 105. In particular, the battery housing 205 may be constructed of a non-conducting, durable polymer. The polymer may further be insulating, both of heat and electricity.

The battery contacts 210 may electrically couple to the device contacts 115. That is, the battery contacts 210 may be corresponding contacts to the device contacts 115, thereby electrically connecting the battery 200 to the electronic device 100. Thus, if the device contacts 115 are pins, the battery contacts 210 may be pinholes that accept the pins or vice versa. If the device contacts 115 are flat contacts, the battery contacts 210 may also be flat contacts. The battery contacts 210 may also be cylindrical pins that couple to the flat contacts. The cylindrical pins may be retractable to further ensure that a coupling takes place. Furthermore, because the battery contacts 210 couple to the device contacts 115, the battery contacts 210 may be disposed on a side of the battery housing 205 so that when the battery 200 is properly received, the battery contacts 210 are properly aligned with the device contacts 115. Therefore, the battery contacts 210 may include a substantially similar number of contacts as the device contacts 115. It should be noted that the battery contacts 210 may be manufactured of a substantially similar material as the device contacts 115 (e.g., conductive metal such as copper, silver, gold, etc.).

The pass around electrical contact 215 may provide an electrical connection to the external power supply. That is, the pass around electrical contact 215 may be coupled to a corresponding contact that is further connected to the external power supply. As will be described in detail below, the corresponding contact may be disposed in a cradle. The pass around electrical contact 215 may substantially circumscribe an outer edge of the battery housing 205. For example, as illustrated, the pass around electrical contact 215 may extend a partial top length, an entire side length, and a partial bottom length of the battery housing 205. In another example, the pass around electrical contact 215 may be singular and extend an entire bottom length, an entire side length, and a partial top length of the battery housing 105. In yet another example, the pass around electrical contact 215 may include a plurality of contacts. The contacts may be disposed on the battery housing 205 in a variety of manners such as extending only across one surface (i.e., any of the six faces) of the battery housing 205; extending across an entire side surface and partially across the top and bottom surfaces of the battery housing 205; etc.; or any combination thereof. The pass around electrical contact 215 may be manufactured of a material substantially similar to the battery contacts 210 (e.g., conducting metal such as copper, silver, gold, etc.). The pass around electrical contact 215 may be recessed, flush, or proud (i.e., extend outward) with respect to the battery housing 205.

It should be noted that the disposition of the pass around electrical contact 215 being on the right and left sides and the bottom side of the battery housing 205 is only exemplary. The pass around electrical contact 215 may be disposed on any outer surface of the battery housing 205. The pass around electrical contact 215 may be attached to the battery housing 205 in a variety of manners. For example, it may be inserted mechanically during manufacture, insert molded, heat staked, adhered, transfer taped, plated directly to the battery housing 205, etc. Furthermore, multiple pass around electrical contacts may be disposed on the battery. For example, at least two pass around electrical contacts may be disposed on a left and right side of the battery housing 205; at least three pass around electrical contacts may be disposed on a top and bottom face of the battery housing 205; etc.

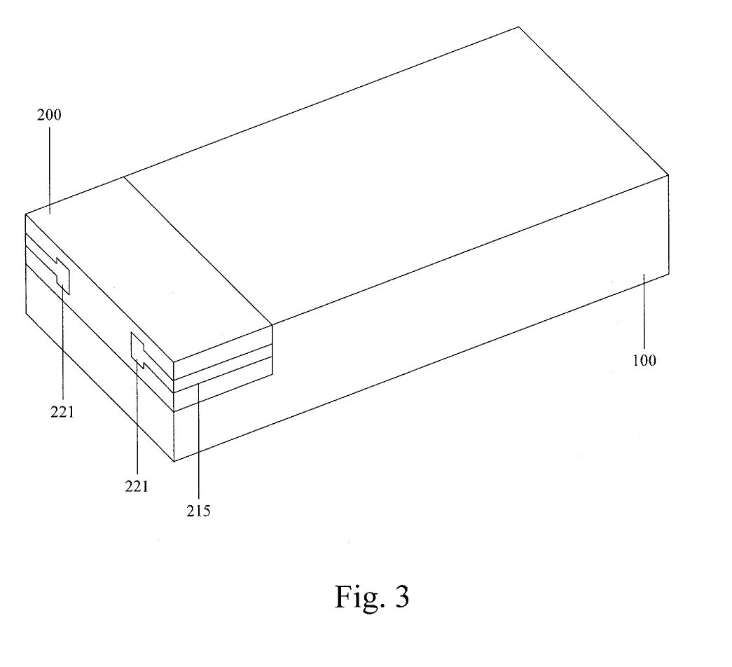

The pass around electrical contact heads 220 may be terminals for the pass around electrical contact 215. As described above, the pass around electrical contact 215 may extend a partial top length of the battery housing 205. Specifically, the pass around electrical contact 215 may extend from both edges of the top length. The pass around electrical contact 215 may terminate at the pass around electrical contact heads 220. Also, as discussed above, the pass around electrical contact 215 may extend a partial bottom length of the battery housing 205. Thus, a substantially similar disposition of corresponding pass around electrical contact heads may be disposed on a bottom side of the battery housing 205. The corresponding pass around electrical contact heads will be described below with reference to FIG. 3. The pass around electrical contact heads 220 may be larger than a width of the pass around electrical contact 215 to facilitate or guarantee a coupling with the secondary device contacts 120. That is, the pass around electrical contact heads 220 may be corresponding contacts for the secondary device contacts 120 in a substantially similar manner as the battery contacts 210 with the device contacts 115. Furthermore, because the pass around electrical contact heads 220 couple to the secondary device contacts 120, the pass around electrical contact heads 220 may be disposed on a side of the battery housing 205 so that when the battery 200 is properly received, the pass around electrical contact heads 220 are properly aligned with the secondary device contacts 115. The pass around electrical contact heads 220 may be manufactured of a substantially similar material as the pass around electrical contact 215.

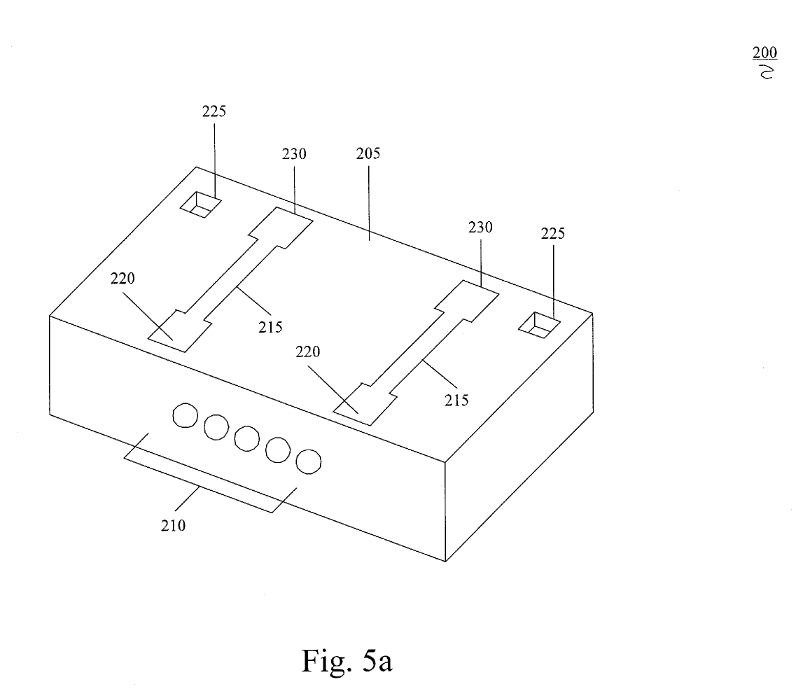

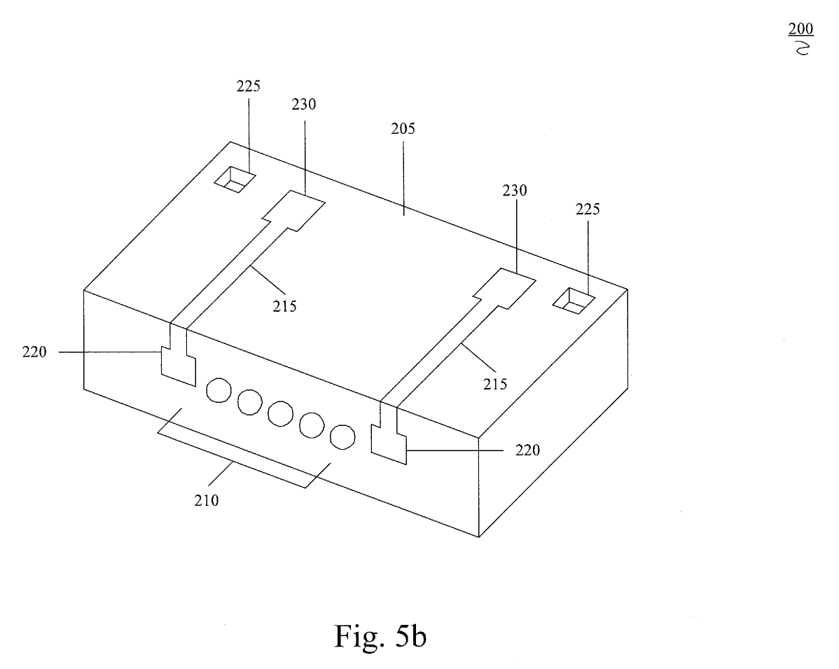

When viewed in its entirety, the pass around electrical contact 215 and the pass around electrical contact heads 220 may be disposed on the battery housing 205 in a variety of manners. For example, as shown in FIG. 5a, the pass around electrical contact 215 and the pass around electrical contact heads 220 may be disposed on a common surface. Furthermore, FIG. 5a illustrates the corresponding pass around electrical contact head 230. That is, the external power supply may couple to the corresponding pass around electrical contact head 230 while the pass around electrical contact head 220 may couple to the secondary device contacts 120. In addition, FIG. 5a illustrates that multiple pass around electrical contacts 215 may be disposed with respective pass around electrical contact head 220 and corresponding pass around electrical contact head 230. It should be noted that the pass around electrical contact 215 and the pass around electrical contact heads 220 may be disposed entirely on opposite sides to that shown in FIG. 5a; perpendicular sides to that shown in FIG. 5a; etc.

As shown in FIG. 5b, the pass around electrical contact 215 may extend at least two surfaces of the battery housing 205. For example, the pass around electrical contact 215 may form a substantial L-shape so that the pass around electrical contact head 220 may be disposed on a common surface as the battery contacts 210. The corresponding pass around electrical contact head 230 may be disposed on a common surface as the locking mechanisms 225. In another embodiment, the pass around electrical contact 215 may extend to an opposing side so that the corresponding pass around electrical contact head 230 may be disposed on a surface opposite the locking mechanisms 225; a surface perpendicular to the locking mechanisms 225; etc.

It should be noted that the battery contacts 210 and the pass through electrical contact heads 220 being disposed on a common surface is only exemplary. Similar to the device contacts 115 and the secondary device contacts 120 of the device 100, the battery contacts 210 may be disposed on the surface as illustrated while the pass through electrical contact heads 220 may be disposed on a perpendicular surface. It should further be noted that the disposition of the battery contacts 210 and the pass through electrical contact heads 220 will correspond to a position and an amount of the device contacts 115 and the secondary device contacts 120, respectively.

The corresponding locking mechanisms 225 may be the counterpart for the locking mechanisms 125 of the electronic device 100. That is, the corresponding locking mechanisms 225 may couple to the locking mechanisms 225 to provide the releasable securing of the battery 200 in the recess 110 of the battery 100. Thus, for example, if the locking mechanisms 125 are screws, the corresponding locking mechanisms 225 may be screw holes. In another example, if the locking mechanisms 125 are retractable inserts, the corresponding locking mechanisms 225 may be holes that receive the inserts.

FIG. 3 shows an assembled view of the electronic device 100 of FIG. 1 with the battery 200 of FIG. 2. The assembled view illustrated when the battery 200 has been received by the electronic device 100 in an operative position. That is, the device contacts 115 may be coupled to the battery contacts 210; the secondary device contacts 120 may be coupled to the pass around electrical contact heads 220; and the locking mechanisms 125 may be coupled to the corresponding locking mechanisms 225. FIG. 3 further shows the corresponding pass around electrical contact heads 221. The pass around electrical contact 215 may include a pass around electrical contact head 220 and corresponding pass around electrical contact head 221. That is, the pass around electrical contact head 220 and the corresponding pass around electrical contact head 221 may be the terminating ends of the pass around electrical contact 215.

As illustrated, when the battery 200 has been properly received in the recess 110 of the electronic device 100, at least a portion of the battery housing 205 may be exposed. The amount and areas of the battery housing 205 that are exposed may be dependent on the type of the recess 110. For example, as illustrated, when the recess 110 is substantially L-shaped, a bottom side, right and left sides, and a back face of the battery housing 205 may be exposed. In particular, the pass around electrical contact 215 that is disposed on the bottom, right, and left sides may also be exposed. In another example, when the recess 110 is a slot, a bottom side of the battery housing 205 may be exposed, thereby the portion of the pass around electrical contact 215 that is disposed on the bottom side is also exposed. In yet another example, when the recess 110 has a square bracket cross section, substantially similar areas of the battery housing 205 and the pass around electrical contact 215 may be exposed as when the recess 110 is substantially L-shaped. In yet another example, when the recess 110 includes the cover or lid, when the cover or lid has been removed, substantially similar areas of the battery housing 205 and the pass around electrical contact 215 may be exposed as when the recess 110 is either substantially L-shaped or a slot.

Once the battery 200 has been received, power supplied to the pass around electrical contact 215 from the external power supply may travel from the corresponding pass around electrical contact heads 221 to the pass around electrical contact heads 220. Thus, the power may also travel to the secondary device contacts 120. The power may be forwarded to a charger disposed within the electronic device 100, to a processor, etc. Therefore, the electronic device 100 may be powered by the external power supply. In addition, if the electronic device 100 is equipped with the charger, the electronic device 100 may forward at least a portion of the power to the device contacts 115 and then to the battery contacts 210 so that the cells of the battery 200 may be recharged.

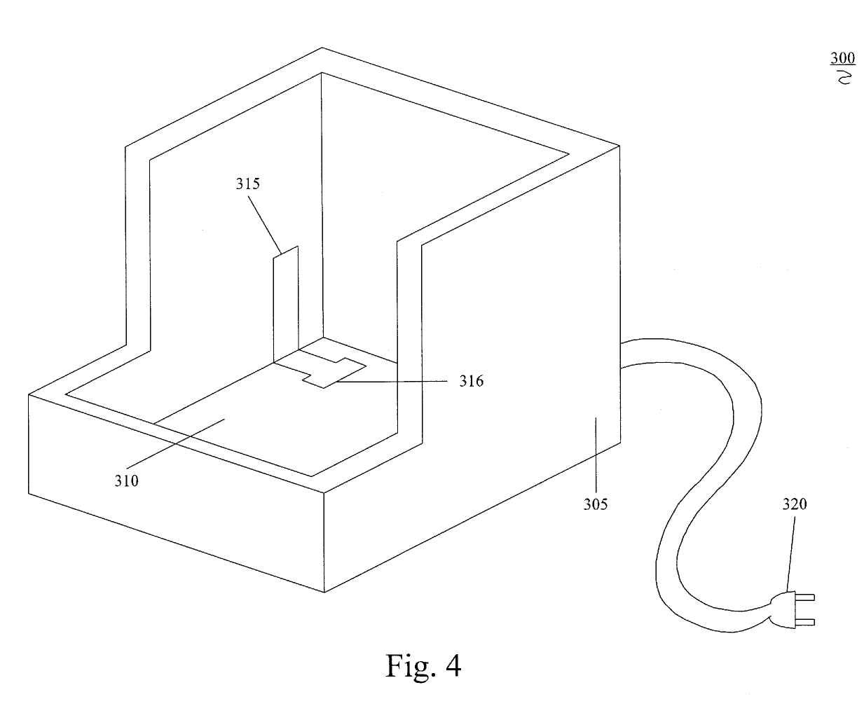

FIG. 4 shows a perspective view of a cradle 300 used to recharge the battery 200 of FIG. 2 according to an exemplary embodiment of the present invention. The cradle 300 may receive the electronic device 100 with the battery 200. That is, the cradle 300 may be configured to receive the electronic device 100 when the battery 200 has been received in the recess 110. When the cradle 300 receives the electronic device 100 with the battery 200, the cradle 300 may also provide a gripping surface so that a user may still utilize the electronic device 100. The cradle 300 may include a cradle housing 305, a cradle recess 310, a cradle contact 315, and a connector 320. It should be noted that the cradle 300 may include other components. For example, the cradle 300 may include an AC to DC converter disposed between the cradle contact 315 and the connector 320. The converter may also be a DC to DC converter (e.g., when the cradle 300 is a car charger that plugs into a cigarette lighter or a larger battery such as that powering a forklift). It should be noted that the use of the cradle 300 is only exemplary. For example, other devices that utilize an appropriate converter may be used as an intermediary connector between the electronic device 100 with the battery 200 to the external power supply.

The cradle housing 305 may be substantially similar (e.g., in composition, in utility, etc.) to the battery housing 205 of the battery 200. That is, the cradle housing 305 may be constructed of substantially similar materials as the battery housing 205. In particular, the cradle housing 305 may be constructed of a non-conducting, durable polymer. As will be explained in detail below, due to the cradle contact 315, in a preferred embodiment, the cradle housing 305 may be insulating. It should be noted that the cradle 300 may include further components (not shown) such as a processor, a memory, a data input arrangement, a display, etc. For example, when the cradle 300 receives the electronic device 100 with the battery 200, the cradle 300 may connect to the electronic device 100 to provide further functionalities such as scanning. In another example, the cradle 300 may show a recharge status via the display. These further components may be disposed at least partially within the cradle housing 305.

The cradle recess 310 may be substantially similar in utility to the recess 110 of the electronic device 100. The cradle recess 310 may be configured to receive the electronic device 100 with the battery 200. As illustrated, the cradle recess 310 may be configured to be large enough in order to receive the electronic device 100 with the battery 200. It should be noted that further components may be disposed in the cradle recess 310. Similar to the recess 110 of the electronic device 100, channels may be disposed to receive rails disposed on the battery housing 205 or the device housing 105, thereby orienting the electronic device 100 with the battery 200 in a proper configuration in the cradle 300. Furthermore, the channels may be disposed on the battery housing 205 or the device housing 105 while the rails may be disposed in the cradle recess 310.

The cradle contact 315 may be disposed within the cradle recess 310. The cradle contact 315 may further include cradle contact heads 316. The cradle contact heads 316 may couple to the corresponding pass around electrical contact heads 221 of the battery 200. When connected, the cradle contact 315 may provide the electrical connection from the external power supply to the pass around electrical contact 215, thereby supplying power to the electronic device 100. The cradle contact 315 and the cradle contact heads 316 may be constructed of substantially similar materials as the pass around electrical contact 215. Furthermore, the cradle contact 315 may slightly extend into the recess 310 (i.e., proud) so that a coupling with the pass around electrical contact 215 may take place. That is, the cradle contact 315 may couple with the pass around electrical contact 215 in additional areas beyond the cradle contact head 316 coupling to the corresponding pass around electrical contact head 221. The cradle contact 315 may also be flush or recessed, depending on the configuration of the pass around electrical contact 215. Furthermore, if extended, the cradle contact 315 may be retractable so that the electronic device 100 with the battery 200 may be securely placed into the cradle 300 (i.e., similar placement if the cradle contact 315 does not extend). The cradle contact heads 316 may also extend and be retractable to substantially guarantee a coupling with the pass around electrical contact heads 221. The cradle contact 315 may permanently have a current passing through it. Thus, when the pass around electrical contact 215 couples to the cradle contact 315, a recharging may take place. In another example, the cradle 300 may include a switch disposed on the housing 305 to activate the cradle contact 315. In yet another example, the cradle 300 may include sensors to detect when the electronic device 100 with the battery 200 has been received to activate the cradle contact 315.

The connector 320 may be electrically connected to the cradle contact 315. The connector 320 may further be connected to the external power supply. It should be noted that the connector 320 may not be directly connected to the cradle contact 315. For example, a charging unit disposed in the cradle housing 305 may serve as an intermediary between the connector 320 and the cradle contact 315 to control an amount of current.

As illustrated in the above description, the pass around electrical contact 215 may be exposed on a periphery of the battery housing 205. Thus, when the pass around electrical contact 215 couples to the external power supply via the cradle contact 315, a separate contact (e.g., secondary device contacts 120 coupled to the pass around electrical contact heads 220) may be utilized to provide the energy to the electronic device 100.

This may prevent the inadvertent electrical connections to other signals in an uncontrolled fashion, for example, during high voltages of an electrostatic discharge events. That is, because conventional charging units utilize a common power path between the device and the battery and between the device and the external power supply, the crossing of signals that occur is highly likely. In contrast, the separation of these paths as described in the exemplary embodiments of the present invention prevents this problem. Furthermore, the insulating properties of the material that is used to manufacture the battery housing 205 may also contribute to render a less likely probability that an electrostatic discharge even occurs from the exposed power path provided by the pass around electrical contact 215.

In another example, conventional charging devices that have the additional contact to connect to the external power supply have increased size and susceptibility to damage to the device. That is, the repeated connection and disconnection to the external power supply may cause wear and tear to the additional contact. Replacement of this contact may be highly intrusive on the device. According to the exemplary embodiments of the present invention, the disposition of the pass around electrical contact 215 on the battery 200 may allow the replacement of only the battery 200 when enough wear and tear have been sustained by the pass around electrical contact 215. Thus, the more costly and fragile electronic device 100 may not require any intrusive procedure to replace components that allow connection to the external power supply. Furthermore, the electronic device 100 may be designed more compactly since only the secondary device contacts 120 are necessary in comparison to a larger contact that receives a connector.

Furthermore, conventional charging devices include connectors that have a plurality of teeth that fit into each other and locking mechanisms that secure directly into the device housing 105. This configuration has a higher likelihood of causing damage when, for example, the connector is inadvertently disconnected without disengaging the locking mechanism. The teeth may also be damaged from the simple process of connecting and disconnecting. The exemplary embodiments of the present invention decrease the wear and tear caused from continual connecting and disconnecting from the external power supply. The connection of the pass around electrical contact 215 with the cradle contact 315 may be a simple touching of conducting materials. Thus, the exemplary embodiments of the present invention may allow additional use of the components used to connect to the external power supply.

It should be noted that the above described exemplary embodiments of the present invention using the pass around electrical contact 215 for recharging purposes is only exemplary. That is, the pass around electrical contact 215 may be utilized for various other purposes. For example, the pass around electrical contact 215 may connect to further hardware devices and, therefore, data signals may be transferred. Various accessories may be attached to the device 100 that may require an exchange of power and/or data signals. That is, the pass around electrical contact 215 may be capable of conducting energy for recharging purposes and data signals for data transmission. The data signals may be transmitted using, for example, data over DC techniques when a common pass around electrical contact 215 is utilized. In another embodiment, the pass around electrical contact 215 may be for recharging purposes only. A second pass around electrical contact may be disposed for data transmission. The pass around electrical contact 215 and the second pass around electrical contact may be electrically isolated from each other.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A battery, comprising:
a housing including a plurality of rechargeable cells;
a plurality of contacts electrically coupled to the rechargeable cells, the plurality of contacts configured to couple to first corresponding contacts of an electronic device; and
a pass around electrical contact electrically isolated on the battery from the plurality of contacts and configured to couple to second corresponding contacts of the electronic device, the pass around electrical contact being further configured to be connected to at least one of an external power supply and a data source.

2. The battery of claim 1, wherein the battery is configured to be received by the electronic device.

3. The battery of claim 2, wherein the pass around electrical contact is at least partially exposed when the battery is received by the electronic device.

4. The battery of claim 2, wherein the battery is received in a recess of the electronic device.

5. The battery of claim 4, further comprising:
a locking mechanism disposed on a housing of the battery to securely hold the battery in the recess.

6. The battery of claim 1, wherein the pass around electrical contact is at least partially disposed on a periphery of the housing.

7. The battery of claim 1, wherein the pass around electrical contact further comprises first contact heads configured to couple to the second corresponding contacts.

8. The battery of claim 7, wherein the first contact heads are disposed on an exterior surface of the housing.

9. The battery of claim 7, wherein the pass around electrical contact further comprises second contact heads configured to couple to the external power supply.

10. The battery of claim 9, wherein the first contact heads are disposed on one of a common surface and a separate surface of the housing as the second contact heads.

11. The battery of claim 1, wherein the pass around electrical contacts are one of recessed, flushed, and proud in relation to the housing.

12. The battery of claim 1, wherein the pass around electrical contact is disposed on the housing by at least one of being mechanically inserted during manufacture, insert molded, a heat staked, adhered, transfer taped, and directly plated.

13. The battery of claim 1, wherein the plurality of contacts and the pass around electrical contact are disposed one of on a common surface of the housing and on separate surfaces of the housing.

14. The battery of claim 1, wherein the pass around electrical contact are disposed at least partially on at least one side of the housing.

15. The battery of claim 1, further comprising:
at least one further pass around electrical contact electrically isolated on the battery from the plurality of contacts and configured to couple to third corresponding contacts of the electronic device, the at least one further pass around electrical contact being further configured to be connected to a data source while the pass around electrical contact is configured to be connected to an external power supply.

16. The battery of claim 15, wherein the pass around electrical contact and the at least one further pass around electrical contact are disposed one of on a common surface and on separate surfaces of the housing.

17. An electronic device, comprising:
a first plurality of contacts coupling to corresponding contacts of a battery, the battery being received in a recess of the electronic device; and
a second plurality of contacts connecting to a pass around electrical contact disposed on a periphery of the battery, the pass around electrical contact being connected to at least one of an external power supply and a data source.

18. The electronic device of claim 17, wherein the first plurality of contacts is one of pins, pinholes, and flat contacts and the corresponding contacts correspond thereto.

19. The electronic device of claim 17, wherein the first plurality of contacts and the second plurality of contacts are disposed one of on a common surface and on separate surfaces.

20. The electronic device of claim 17, wherein the external power supply provides energy to the electronic device to perform at least one of a powering of the electronic device and a recharging of the battery.

21. The electronic device of claim 17, wherein the recess is one of a substantial L-shaped recess, a substantial square bracket recess, and a slot.

22. The electronic device of claim 21, wherein, when the recess is one of a substantial L-shaped recess and a substantial square bracket recess, the pass around electrical contact is exposed on at least two sides of the battery.

23. The electronic device of claim 21, wherein, when the recess is a slot, the pass around electrical contact is exposed on one side of the battery.

24. The electronic device of claim 17, further comprising:
a lid covering the recess.

25. The electronic device of claim 17, wherein the lid is removed when the pass around electrical contact is connected to the external power supply.

26. The electronic device of claim 17, further comprising:
a locking mechanism disposed within the recess to securely hold the battery.

26. A battery, comprising:
a housing including a plurality of rechargeable cells;
a plurality of contact means for coupling to first corresponding contact means of an electronic device, the plurality of contact means electrically coupled to the rechargeable cells; and
a pass around electrical contact means for connecting to at least one of an external power supply and a data source, the pass around electrical contact means being electrically isolated on the battery from the plurality of contacts means and being configured to couple to second corresponding contact means of the electronic device.

27. An electronic device, comprising:
a first coupling means for coupling to a first corresponding coupling means of a battery, the battery being received in a recess of the electronic device; and
a second coupling means for coupling to a second corresponding coupling means, the second corresponding coupling means being disposed on a periphery of the battery, the second corresponding coupling means being connected to at least one of an external power supply and a data source.
